(19) United States
(12) Patent Application Publication
(10) Pub. No.: US 2021/0287119 A1
(43) Pub. Date: Sep. 16, 2021

(54) SYSTEMS AND METHODS FOR MITIGATION BIAS IN MACHINE LEARNING MODEL OUTPUT

(71) Applicant: ATB FINANCIAL, Edmonton (CA)

(72) Inventors: Chandra Catherine RINK, Calgary (CA); Saeed El Khair NUSRI, Calgary (CA); Nikoo SABZEVAR, Calgary (CA); Susan Marie McGILL, Calgary (CA)

(21) Appl. No.: 17/198,743

(22) Filed: Mar. 11, 2021

Related U.S. Application Data
(60) Provisional application No. 62/988,737, filed on Mar. 12, 2020.

(51) Int. Cl. G06N 5/04; G06N 20/00

(52) U.S. Cl. CPC G06N 5/04; G06N 20/00

(57) ABSTRACT

Systems and methods for generating machine learning model output from an input data set is provided. The system includes a processor and a memory coupled to the processor. The memory may store processor-executable instructions that, when executed, configure the processor to: obtain a qualitative data set; determine a regularization threshold value based on the qualitative data set for regularizing the machine learning output; determine a quantitative feedback score for the input data set, wherein the quantitative feedback score includes a bias-detection indication value; determine an adjustment parameter based on the quantitative feedback score and the regularization threshold value; and update the machine learning model based on the determined adjustment parameter.

### CROSS REFERENCE TO RELATED APPLICATIONS

This application claims priority from U.S. provisional patent application No. 62/988,737, entitled “SYSTEMS AND METHODS FOR MITIGATION BIAS IN MACHINE LEARNING MODEL OUTPUT”, filed on Mar. 12, 2020, the entire contents of which are hereby incorporated by reference herein.

### FIELD

Embodiments of the present disclosure generally relate to the field of machine learning, and in particular to systems and methods of generating machine learning model output.

### BACKGROUND

Computing systems may be configured to generate machine learning output based on patterns and inferences from previously analyzed data sets. In some embodiments, machine learning applications may be based on computational statistics and may be focused on providing predictive analysis.

### SUMMARY

In one aspect, the present disclosure provides a system for generating machine learning output from an input data set. The system may include: a processor and a memory coupled to the processor. The memory may store processor-executable instructions that, when executed, configure the processor to: obtain a qualitative data set; determine a regularization threshold value based on the qualitative data set for regularizing the machine learning output; determine a quantitative feedback score for the input data set, wherein the quantitative feedback score includes a bias-detection indication value; determine an adjustment parameter based on the quantitative feedback score and the regularization threshold value; and update the machine learning model based on the determined adjustment parameter.

In another aspect, the present disclosure provides a method for generating machine learning model output from an input data set. The method may include: obtaining a qualitative data set; determining a regularization threshold value based on the qualitative data set for regularizing the machine learning output; determining a quantitative feedback score for the input data set, wherein the quantitative feedback score includes a bias-detection indication value; determining an adjustment parameter based on the quantitative feedback score and the regularization threshold value; and updating the machine learning model based on the determined adjustment parameter.

In another aspect, the present disclosure provides a system for generating machine learning output. The system may include: a processor and a memory coupled to the processor. The memory may store processor-executable instructions that, when executed, configure the processor to: obtain a bias-reduced data set; generate a machine learning model based on the bias-reduced data set; determine that the machine learning model includes model behaviour bias; generate a quantitative feedback score based on the determined model behaviour bias; receive a qualitative data set and generate a qualitative feedback score based on the qualitative data set; and update the machine learning model based on a combination of the quantitative feedback score and the qualitative feedback score.

In another aspect, the present disclosure provides a method for generating machine learning output. The method may include: obtaining a bias-reduced data set; generating a machine learning model based on the bias-reduced data set; determining that the machine learning model includes model behaviour bias; generating a quantitative feedback score based on the determined model behaviour bias; receiving a qualitative data set and generate a qualitative feedback score based on the qualitative data set; and updating the machine learning model based on a combination of the quantitative feedback score and the qualitative feedback score.

In another aspect, a non-transitory computer-readable medium or media having stored thereon machine interpretable instructions which, when executed by a processor may cause the processor to perform one or more methods described herein.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a system for generating machine learning model output, in accordance with an embodiment of the present disclosure;

FIG. 2 illustrates a flow chart diagram of an analytical workflow, in accordance with an embodiment of the present disclosure;

FIG. 3 illustrates a flow chart diagram of a workflow including a combination of quantitative feedback and qualitative feedback, in accordance with an embodiment of the present disclosure;

FIG. 4 illustrates a graphical user interface illustrating classification of machine learning output, in accordance with an embodiment of the present disclosure;

FIG. 5 illustrates a flowchart of a method of generating machine learning model output, in accordance with an embodiment of the present disclosure;

FIG. 6 illustrates a flowchart of a method of reducing sensitive data set feature importance, in accordance with an embodiment of the present disclosure;

FIG. 7 illustrates a sample bias mitigation report, in accordance with an embodiment of the present disclosure;

FIG. 8 illustrates a sample of a component of a bias mitigation report, in accordance with another embodiment of the present disclosure;

FIG. 9 illustrates a sample component of a bias mitigation report, in accordance with another embodiment of the present disclosure; and

FIG. 10 illustrates a block diagram of a computing device, in accordance with an embodiment of the present disclosure.

### DETAILED DESCRIPTION

Computing systems may be configured to conduct data set analysis based on machine learning models. A machine learning model may be a “black box” viewed in terms of data input and data output. In some examples, relying on training data sets that may be unrepresentative, misinformed, or include unintended biases for generating data analytic models may lead to inherently biased machine learning models and machine learning model outputs.

Further, without knowledge of functions conducted by the generated machine learning model, machine learning model outputs may be subject to one or more unidentified biases. Bias may be manifested in a model output when providing an advantage to a certain group over another group in an unexplained or unfair way. Further, machine learning model outputs may be based on misinformed or unintended machine learning model parameters, and the machine learning model output may not be explainable. Explainability includes identification of factors or data entry values which lead to a machine learning model output.

Computing system users may have limited knowledge of internal operations of the machine learning model. When computing devices conduct operations for generating machine learning model output based primarily on machine learning models, the output may be subject to inherent biases of the machine learning model and training data sets used to train the machine learning model. When a computing system user relies primarily on their own analysis of a data set for providing a decision output, the decision output may be affected by inherent biases of the data set or biases of the user's decision making process. For example, the computing system user may not appreciate the context of big data sets.

As knowledge of operations conducted by the machine learning model may be limited, systems and methods of generating machine learning model output in combination with identifying bias, providing explainability, and identifying privacy or consent concerns may be desirable.

In some embodiments, machine learning models may be subject to regularization, which may be optimization operations for adjusting residuals. By adjusting residuals, operations of machine learning models may avoid overfitting when parameters of a regression model may be learned. As an illustrating example, with linear regression models, Ordinary Least Square (OLS), which defines a function by which parameter estimates (e.g., intercepts and slopes), may be calculated. In some examples, the sum of squared residuals (e.g., error rate) may be minimized.

Regularization operations may include operations for adjusting the OLS function to weigh residuals and increase parameter stability. In some examples, operations of machine learning models may generate a model that may fit training data less optimally than the OLS function, but may increase model output accuracy because the model may be less sensitive to extreme variance in input data sets (e.g., less sensitive to outlier data).

In some embodiments of regularization, a loss function may be augmented to minimize a sum of squared residuals and to adjust parameter size estimates. As an illustrating example, the following equation illustrates regularization of a Ridge regression model:

$${L}_{ridge} ( β ) = {\sum }_{i = 1}^{ } {( {y}_{i} - {x}_{i}^{J} β )}^{2} + λ {\sum }_{j = 1}^{m} {β}_{j}^{2}$$

where A may be chosen by minimizing cross-validated residuals from a set of P values of A, and where a Sum of Squared Residuals (SSRₚ)=|y−y_{test,k}|² for a data set may be split into K folds. In the present example, the objective may be to identify λₒₚₜ where λₒₚₜ=argminₚ SSRₚ.

Systems and methods for adjusting target data set types based on bias or disparate impact scores and based on further adjustment parameters for balancing bias reduction and machine learning model prediction accuracy may be desirable.

Systems and methods described herein may include operations for determining one or more adjustment parameters for balancing: (i) bias reduction in machine learning model output and (ii) machine learning model prediction accuracy. In some embodiments, the systems and methods described herein may include operations based on a combination of disparate impact scores and based on identified target data set types. The target data set types may include pre-selected sensitive variables identified based on received qualitative input. In some embodiments, the qualitative data input may be based on defined lists of personally identifiable information (PII) or sensitive data attributes, including age, race, geographical location or gender.

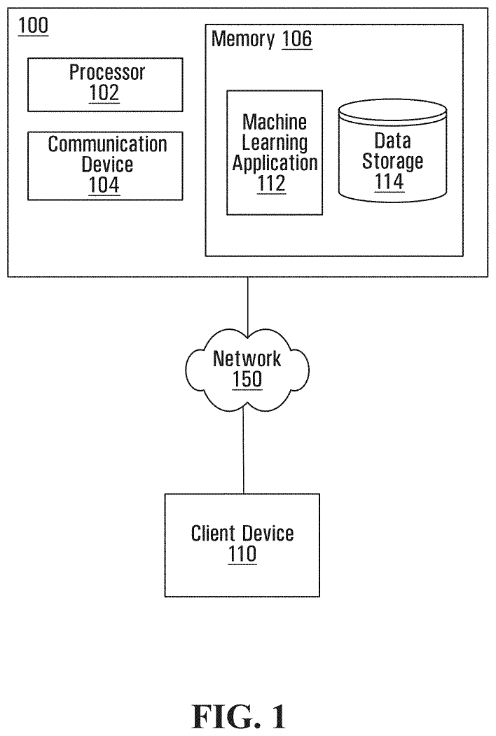

Reference is made to FIG. 1, which illustrates a system 100 for generating machine learning model output, in accordance with an embodiment of the present disclosure. The system 100 may transmit and/or receive data messages to/from a client device 110 via a network 150. The network 150 may include a wired or wireless wide area network (WAN), local area network (LAN), a combination thereof, or the like.

In FIG. 1, a single client device 110 is illustrated; however, the system 100 for generating machine learning model output may transmit and/or receive data messages to/from any number of client devices 110 via the network 150.

In some examples, the client device 110 may be a data source device. The system 100 may receive one or more data sets from the client device 110 and may conduct operations for analyzing the one or more data sets based on a machine learning model, and generating machine learning model output.

In some examples, the client device 110 may be associated with a user of the system 100 for generating machine learning output. The client device 110 may be configured to receive qualitative data input from the user and may be configured to transmit the qualitative data input as a qualitative data set to the system 100. As will be described herein, the system 100 may update machine learning models based on the received qualitative data set.

The system 100 includes a processor 102 configured to implement processor readable instructions that, when executed, configure the processor 102 to conduct operations described herein. For example, the system 100 may be configured to conduct operations for generating machine learning model output and for generating, for display, a user interface to classify bias-reduced output based on at least one analytical dimension. In some examples, the at least one analytical dimension may include at least one of transparency & explainability, bias & intentionality, privacy, or agency & consent. Other examples of analytical dimensions may be contemplated.

The system 100 includes a communication device 104 to communicate with other computing devices, to access or connect to network resources, or to perform other computing applications by connecting to a network (or multiple networks) capable of carrying data. In some embodiments, the network 150 may include the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including combination of these. In some examples, the communication device 104 may include one or more busses, interconnects, wires, circuits, and/or any other connection and/or control circuit, or combination thereof. The communication device 104 may provide an interface for communicating data between components of a single device or circuit.

The system may include memory 106. The memory 106 may include one or a combination of computer memory, such as static random-access memory (SRAM), random-access memory (RAM), read-only memory (ROM), electro-optical memory, magneto-optical memory, erasable programmable read-only memory (EPROM), and electrically-erasable programmable read-only memory (EEPROM), Ferroelectric RAM (FRAM) or the like.

The memory 106 may store a machine learning application 112 including processor readable instructions for conducting operations described herein. In some examples, the machine learning application 112 may include operations for generating machine learning model output. As will be described in the present disclosure, the processor may generate a user interface to display classifications of bias-reduced output based on at least one analytical dimension, including at least one of transparency & explainability, bias & intentionality, privacy, or agency & consent.

The system 100 may include a data storage 114. In some embodiments, the data storage 114 may be a secure data store. In some embodiments, the data storage 114 may store input data sets, such as image data, training data sets, or the like. In some embodiments, the data storage 114 may store thresholding data associated with determining whether a data set, a machine learning model, or a results interpretation model may include bias beyond an identified threshold amount of quantitatively identified bias. In some embodiments, the data storage 114 may store a series of qualitative survey templates or a series of data sets associated with qualitative layer analysis of the system 100. In some embodiments, the thresholding data may include thresholds for determining adjustment parameters for updating machine learning models.

The client device 110 may be a computing device including a processor, memory, and a communication interface. In some embodiments, the client device 110 may be a computing device associated with a local area network. The client device 110 may be connected to the local area network and may transmit one or more data sets to the system 100. Other operations may be contemplated.

The systems and methods described herein may include operations for updating machine learning models based on identified sensitive data types and/or based on determined quantitative scores, such as disparity impact ratios, statistical parity, predictive parity, or skewness measures. Other quantitative scores may be contemplated.

To illustrate features of the present disclosure, examples described herein may conduct operations on data entries based on the German Credit data set. It may be appreciated that the systems and methods described in the present disclosure may include operations conducted on data entries of other data sets.

In some embodiments, the German Credit data set may include a series of data entries associated with example entities described by a set of attributes for determining good or bad credit risks (e.g., “should a mortgage loan with a home-equity line of credit be offered to the mortgage applicant?”). In some embodiments, the German Credit data set may include data entries associated with features/attributes such as: creditability, account balance, duration of credit month, payment status of previous credit, credit amount, value of savings stocks, length of current employment, sex & marital status, guarantors, occupation, foreign worker, etc. It may be appreciated that systems and methods described in the present disclosure may receive any other data sets.

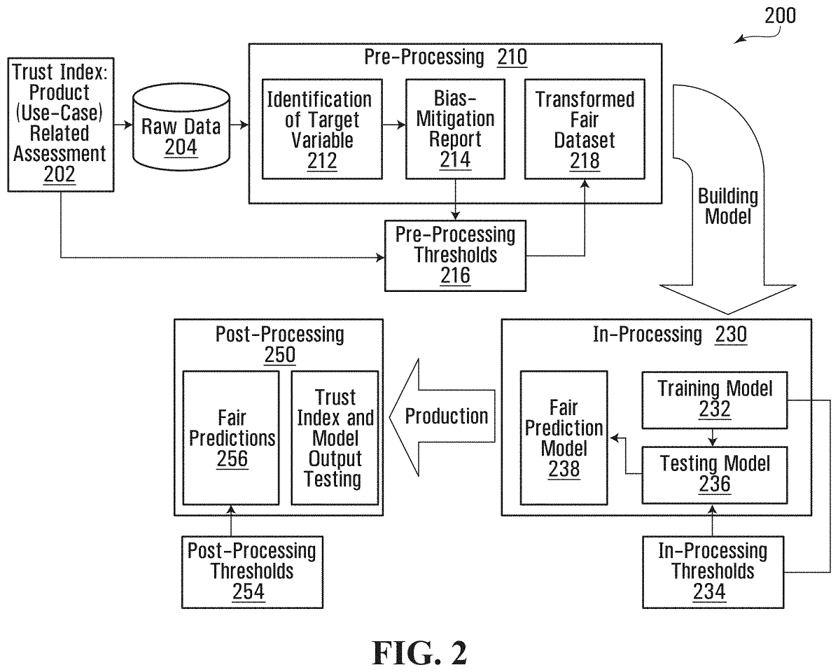

Reference is made to FIG. 2, which illustrates a flow chart diagram of an analytical workflow 200, in accordance with an embodiment of the present disclosure. Operations of the analytical workflow may be conducted by the processor 102 of the system 100 (FIG. 1). Processor readable instructions may be stored in the memory 106 and may be associated with the machine learning application 112 or other processor readable applications not illustrated in FIG. 1.

The analytical workflow 200 may include a pre-processing stage 210, an in-processing stage 230, and a post-processing stage 250. In some embodiments, the system 100 may conduct operations for reweighing data sets, adversarial debiasing, or equalized odds post-processing, among other operations, based on feedback loop operations. The feedback loop operations may be triggered based on thresholds of one or more data dimensions. In some embodiments, data dimensions may include fairness, transparency & explainability, bias & intentionality, privacy, or agency & consent.

At 202, the processor may receive a qualitative data set. In some embodiments, the qualitative data set may be associated with a product (use-case) related assessment. In some embodiments, the qualitative data set may be based on user input associated with survey questions. The survey questions may be based on one or more analytical dimensions. The received user input may be a qualitative, product-related data collection process for identifying the analytical objectives of the machine learning system. As illustrating examples, the user input may be based on survey questions such as: “Are customers being impacted at an individual level?”, “Does your solution intend to use personally identifiable information (PII) data?”, or “How important is model explainability to use-case and stakeholders?”. Other example survey questions are described in the present disclosure.

At the pre-processing stage 210, the processor 102 may receive a raw data set 204 and may determine attribute relationships among data entries within the raw data set. In some embodiments, the processor may pre-process the raw data set prior to providing the data set to model generation or refinement operations to identify and/or reduce potential biases within the raw data set. Reduced data entries associated with data skew or other unintended data artifacts may be reduced prior to generating or refining a machine learning model.

At 212, the processor may conduct operations to identify target variables based on the received qualitative data set (from operation 202) and the raw data set 204. In some embodiments, the processor may identify, based on the qualitative data set, that the machine learning model objective may be for determining user “creditability”.

In some embodiments, the processor may identify or preselect sensitive data types or sensitive variables based on the received qualitative data set. For example, the processor may determine machine learning model objectives (e.g., balancing desired bias removal versus machine learning model prediction accuracy) and may determine adjustment parameters for the identified sensitive data types or sensitive variables.

In some embodiments, the processor may determine skewness in the raw data set 204. In some embodiments, the processor may conduct operations of a fairness assessment based on the raw data set 204. In some examples, the processor may identify disparate impact based on one or more prior-identified sensitive data types. In some embodiments, the processor may determine statistical imparity measures based on one or more prior-identified sensitive data types. In some examples, the processor may identify predictive parity measures based on a combination pair of identified data types in the raw data set 204. As an illustrating example, the processor may determine that particular “applicants” associated with entries in the German Credit data set may be treated differently in terms of “creditability” based on a “payment status of previous credit” feature, assuming that creditability applicants have similar “apartment type”.

In some embodiments, the processor may analyze the received raw data set 204 and may generate a bias mitigation report 214. The bias mitigation report 214 may include data or user interface output illustrating skewness assessment of the raw data set 204, fairness assessment of the raw data set 204, equal opportunity assessment of the plurality of creditability applicants of the raw data set 204, or equalized odds (e.g., indication of false positive rates) based on analysis of the raw data set 204. Other features of the bias mitigation report 214 may be contemplated.

In some embodiments, the processor may conduct a sensitivity analysis based on the raw data set 204. The sensitivity analysis may be based on one or more models, such as a linear/multi-variate regression, logistic regression model, a random forest model, and/or a multilayer perceptron model. Based on the respective models, in some examples, the processor may determine measures, such as accuracy, precision, recall, confusion matrices, or Area Under the Receiver Operating Curve (AUROC). It may be appreciated that the processor may be configured to conduct operations to determine other types of statistical measures.

At 218, the processor may transform the raw data set 204 into a transformed data set based on pre-processing thresholds 216. In some embodiments, the thresholds may be based on received qualitative data sets (e.g., operation at 202), such as user responses to survey questions associated with one or more analytical dimensions. In some examples, the pre-processing thresholds may be based on analytical objectives of the machine learning system. To illustrate, the thresholds may be for identifying whether data entries may be subject to disparate impact beyond a threshold value. In some examples, thresholds may be for identifying skewness or probability/imbalance in received data sets. Other threshold values or types may be contemplated.

In some examples, operations associated with pre-processing thresholds 216 may include operations for identifying data bias based on statistical bias (e.g., skew, kurtosis, variance), minority class recognition, disparity impact identification, or sensitive attribute identification. The processor may be configured to provide indications such as: probability mass or distribution functions of variables, identification of missing data or duplicate data, identification of data-type misclassification, identification of skewed distributions or outlier data entries, or identification of minority class within a variable (e.g., extreme value distributions).

In some embodiments, the processor, during the pre-processing stage 210, may generate quantitative measures (e.g., skew probability, minority category detection, etc.) and may assign weights to data entries associated with detected bias for generating a transformed data set 218 based on the received raw data set 204.

As described, the German Credit data set may include a series of data entries associated with entities described by a set of attributes for identifying good or bad credit risks. The German Credit data set may include data entries associated with features/attributes such as: account balance, concurrent credits, duration at current address, foreign worker status, guarantors, number of dependents, or other features.

In some embodiments, the processor may conduct regularization to penalize residuals to avoid overfitting when parameters of a regression model are learned. In some embodiments, the processor may conduct operations to determine an adjustment parameter based on a combination of: (i) determined disparity impact based on one or more data set attributes; and (ii) preselected sensitive variables. In some examples, the preselected sensitive variables may be based on the qualitative, product-related data collection process (e.g., at 202) and may be based on cross-referencing data set attributes against a list of PII and sensitive data attributes, including age, race, geographical location, and gender.

The processor may conduct operations of regularization based on determining disparate impact of one or more data set attributes and identifying a penalty parameter. In some examples, the penalty parameter may be a parameter which may impose penalty on sensitive data attributes.

In some embodiments, the processor may conduct operations based on a combination of disparate impact (DI) and preselected sensitive data attributes (e.g., identified through a qualitative, product-related data collection process and referenced against the list of PII or sensitive data attributes, including age, race, geographical location, and gender) to determine values of the penalty parameter (e.g., λⱼ). In some situations, the lower the disparate impact, the more biased the data attribute may be.

In some examples, the processor may determine disparate impact based on an “80% rule”, where the selection rate of a protected group should be at least 80% of the selection rate of the non-protected group. To illustrate, a penalty parameter λⱼ may be identified based on:

$${λ}_{j} = \{ \begin{matrix}1 - {DI}_{j} , {DI}_{j} < 0.8 \\ 0 , {DI}_{j} \geq 0.8\end{matrix} \} , where j represents features$$

In the present example, the pre-processing threshold of 0.8 may be associated with a disparity impact ratio value. Other threshold values may be contemplated and may be based on qualitative data collection processes (e.g., at 202). In the present example, the processor determines disparate impact; however, other metrics or analytical methods for determining penalty parameter values associated with sensitive data attributes may be contemplated.

Table 1 includes example data based on a modified German Credit data set. In the present example, the modified German Credit data set includes two “dummy” features. The “Dummy 1” feature may include high skew towards creditability and the “Dummy 2” feature may include a high confounding effect on other variables. In the present example, the “Dummy 1” feature may be a “sensitive” feature.

Table 1 illustrates examples of disparity impact ratios associated with a series of preselected sensitive variables/features, and a listing of associated penalty parameters.

TABLE 1
Example Disparity Impact and Regularization/Penalty Rates

| | Disparity | λⱼ* (Features |
|---|---|---|
| Features | Ratio (DIⱼ) | penalties) |
| Account Balance | 0.63 | 0.37 |
| Concurrent Credits | 0.82 | 0.00 |
| Dummy 1 | 0.0 | 1.00 |
| Dummy 2 | 0.49 | 0.51 |
| Duration in Current Address | 0.98 | 0.00 |
| Foreign Worker | 1.00 | 0.00 |
| Guarantors | 0.86 | 0.00 |
| Instalment Percent | 0.90 | 0.00 |
| Length of Current Employment | 0.78 | 0.22 |
| Most Valuable Available Asset | 0.76 | 0.24 |
| No of Credits at this Bank | 0.85 | 0.00 |
| No of dependants | 1.00 | 0.00 |
| Occupation | 0.92 | 0.00 |
| Payment Status of Previous Credit | 0.45 | 0.55 |
| Purpose | 0.63 | 0.37 |
| Sex & Marital Status | 0.65 | 0.35 |
| Telephone | 1.00 | 0.00 |
| Type of apartment | 0.83 | 0.00 |
| Value Savings Stocks | 0.74 | 0.26 |

In the example of Table 1, the “Dummy 1” feature has the lowest disparate impact because it is highly biased in the prediction of “creditability”. The processor may identify a relatively high penalty/regularization rate as compared to other features of the modified German Credit data set.

Continuing with the above example, as the disparate impact classification may be a binary classification (e.g., based on a threshold value of 0.8), the processor may conduct operations of a logistic regression. In the present example, two models may be evaluated to identify an optimal feature importance (0 value) such that loss functions are minimized. Table 2 shows example cross entropy loss functions.

TABLE 2
(Regularized) Cross Entropy Loss Function

| Regular Cross | Penalized/Regularized Cross |
|---|---|
| Entropy Loss Function | Entropy Loss Function |
| $\begin{matrix}J = \frac{- 1}{m} [ {\sum }_{i = 1}^{m} {y}_{i} log ( {h}_{θ} ( {x}_{i} ) ) + \\ ( 1 - {y}_{i} ) log ( 1 - {h}_{θ} ( {x}_{i} ) ) ]\end{matrix}$ | $\begin{matrix}{J}_{ λ} = \frac{- 1}{m} [ {\sum }_{i = 1}^{m} {y}_{j} log ( {h}_{θ} ( {x}_{i} ) ) + \\ ( 1 - {y}_{i} ) log ( 1 - {h}_{θ} ( {x}_{i} ) ) ] + \frac{v}{2 m} {\sum }_{j = 1}^{n} {λ}_{j}^{*} {θ}_{j}^{2}\end{matrix}$ |

In the above example, the variable v may be a constant associated with penalty adjustments, which may be known as a penalty multiplier. In the above example, J and J_{λ} may be cross entropy loss functions for any h_{θ} function. For instance, h_{θ}(z) may be a logistic regression function:

$${h}_{θ} ( z ) = \frac{1}{1 + {e}^{- {θ}^{{T}_{z}}}}$$

The first model is a regular loss function for a logistic regression model and the second model is a penalized/regularized cross entropy loss function, in accordance with an embodiment of the present disclosure. The second model may include penalize (e.g., adjust) features based on identified disparate impact.

In the above examples, (xᵢ, yᵢ) may be data points and m and n may be the number of data points and the number of features, respectively. The variable θ may be the feature importance optimized based on the loss functions. Further, λⱼ* may be the regularization parameter that restricts feature importance associated with features having a relatively higher disparate impact. Example regularization parameters and associated disparate impact ratios are illustrated in Table 1 for the modified German Credit data set. In some embodiments disclosed herein, the penalized/regularized cross entropy loss function may have a global optimum, whereby the proposed problem may be solvable.

In some embodiments, the processor may conduct operations for penalizing sensitive parameters while maintaining machine learning model prediction accuracy.

As described, the processor may, at 218, generate the transformed data set, and may generate a machine learning model or refine a previously generated machine learning model based on the transformed data set. The processor may provide, as an input, the generated or refined machine learning model to the first in-processing stage 230. By pre-processing the raw data set 204 prior to providing the data set as an input for model generation or to the first in-processing stage 230, potential biases within the raw data set 204 may be identified or reduced, thereby reducing data entries that may be associated with skewed data or other unintended data artifacts prior to generating or refining a machine learning model.

At the in-processing stage 230, the processor may generate a training model 232 or a machine learning model based at least on the bias-reduced data set generated at the pre-processing stage 210. The processor may conduct operations based on in-processing thresholds 234. In some embodiments, operations associated with in-processing thresholds 234 may include defined thresholds associated with operations to generate quantitative metrics for identifying potential biases within the training model 232. For example, operations may include calculating metrics such as root mean square error (RMSE), area under the curve of the receiver operating characteristics (AUROC), confusion matrices, or the like for describing performance of classification models. In some embodiments, in-processing thresholds 234 may be based on received qualitative data sets that include responses to survey user input across one or more data dimensions. In some embodiments, data dimensions may include fairness, transparency & explainability, bias & intentionality, privacy, or agency & consent.

The processor may generate a testing model 236 based on the training model 232 and/or based on the in-processing thresholds 234 for generating an updated machine learning model or fair prediction model 238. In some embodiments, the processor may generate the fair prediction model 238 based on identifying disparate impact (or other quantitative feedback score for identifying learning model bias) and based on regularization/penalty parameters similar to examples with reference to the pre-processing stage 210.

At the post-processing stage 250, the processor may generate machine learning model output or fair predictions based on the transformed data set 218 and/or the fair prediction model 238, and may generate interpretive analysis. In some embodiments, the processor may generate fair predictions 256 based on trust indices (e.g., based on the product related assessment at 202) and may conduct output testing. Similar to embodiments described with reference to the pre-processing stage 210, in some embodiments, the processor may generate the machine learning model output (e.g., fair predictions 256) based on identifying disparate impact (or other quantitative feedback score) and based on regularization/penalty parameters akin to examples described with reference to the pre-processing stage 210.

In some embodiments, the processor may generate machine learning model output or fair predictions 256 based on post-processing thresholds 254. The post-processing thresholds 254 may be based on the received qualitative data sets (e.g., operation at 202), such as user responses to survey questions associated with one or more analytical dimensions. In some embodiments, the post-processing thresholds 254 may be based on analytical objectives of the machine learning system. As an illustrating example, the post-processing threshold 254 may be for identifying whether one or more machine learning output may be subject to disparate impact beyond a threshold value and, if so, the processor may adjust prominence of preselected sensitive features of data sets (e.g., raw data set 204). In some other examples, the post-processing thresholds 254 may be associated with sensitivity analysis, fairness assessments, data skewness analysis, or the other types of analysis.

In some scenarios, it may be desirable to include identified bias when training a machine learning model to achieve prediction accuracy. However, in some scenarios, it may be desirable to train the machine learning model to reduce an identified bias or preference for a subset of data entries. Embodiments of the present disclosure provide systems and methods of feeding back the desirable reduction of identified bias or preference based on a qualitative, data-collection process.

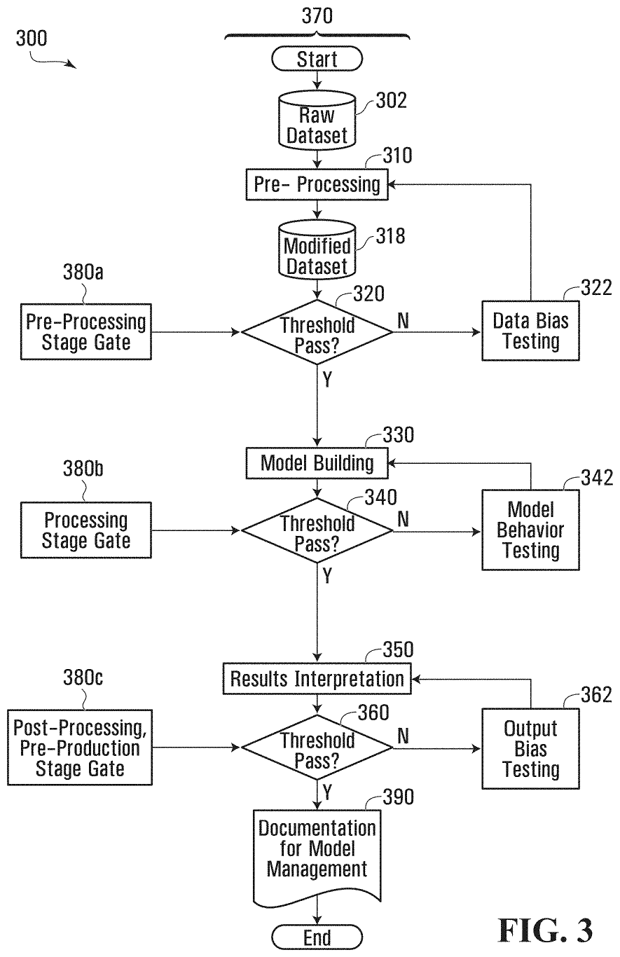

FIG. 3 illustrates a flow chart diagram of a workflow 300 including a combination of quantitative feedback and qualitative feedback for generating bias-reduced data sets, an updated machine learning model, or an updated results interpretation model, in accordance with an embodiment of the present disclosure. Operations of the workflow 300 may be conducted by the processor 102 of the system 100 (FIG. 1). Processor readable instructions may be stored in the memory 106 and may be associated with the machine learning application 112 or other processor readable applications not illustrated in FIG. 1.

The workflow 300 may include a combination of a quantitative workflow 370 and a qualitative workflow. In some embodiments, the quantitative workflow 370 illustrated in FIG. 3 may correspond to operations described in the quantitative analysis workflow 200 of FIG. 2. In some embodiments, the qualitative workflow may include one or more of a pre-processing stage gate 380a, a processing stage gate 380b, or a post-processing/pre-production stage gate 380c.

At a pre-processing stage 310, the processor may receive a raw data set 302 and may determine attribute relationships among data entries within the raw data set. In some embodiments, during the pre-processing stage 310, the processor may assign weights to data entries associated with detected bias for generating a modified data set 318. Prior to generating or updating a machine learning model based on the modified data set 318, the processor may conduct operations for determining whether the modified data set 318 pass determined thresholds 320.

In the scenario that the modified data set 318 may not pass determined thresholds 320, the processor may conduct operations for data bias testing 322. Operations associated with data bias testing 322 may include outlier identification, skewness or probability, distribution/mass functions, minority class detection, outlier detection, lack of attribute fairness, disparate impact remover, or reweighing attributes. Other data bias testing calculations may be contemplated.

Based on the data bias testing 322, the processor may generate a quantitative data bias score and update the pre-processing stage 310 based on the quantitative data bias score.

In some embodiments, it may be desirable to combine quantitative feedback and qualitative feedback for updating the pre-processing stage 310. In some embodiments, the qualitative workflow may include operations for receiving a qualitative data set and generating a qualitative feedback score for updating the pre-processing stage 310. Qualitative feedback scores may be associated with one or more analytical dimension. Analytical dimensions may include transparency & explainability, bias & fairness, privacy, and agency & consent.

In some embodiments, the qualitative workflow may include a pre-processing stage gate 380a. At the pre-processing stage gate 380a, the processor may receive the qualitative data set and generate criteria data for setting up a threshold value 320 for data bias testing 322. For example, the qualitative data set may include user input associated with survey questions. Example survey questions are described in the present disclosure.

In some embodiments, the processor may receive user input associated with one or more survey questions associated with each of the analytical dimensions, and may transform the received user input into a qualitative data set. In some embodiments, received user input may be associated with threshold parameters. For example, the received user input may be associated with identifying a skewness threshold value of 80%, or any other threshold value.

Example survey questions associated with received user input for updating the pre-processing stage 310 or for setting up one or more threshold values may include one or more of the following:

| | Questions/Instructions Associated with Qualitative |
|---|---|
| Dimension | Data Set Input |
| Transparency & | Is your solution impacting customers at an |
| Explainability | individual level? |
| | How critical is Model Explainability for your Use |
| | Case & Stakeholders? |
| | Please select your Target Variable. |
| | Please select Data Attributes required for the |
| | project. |
| Fairness & Bias | Are the prediction(s) intended to impact customer |
| | segments differently? |
| | Will there be a ‘human-in-the-loop’ in production”? |
| | If so, where?; If not, why? |
| Privacy | Does your solution intend to use personally |
| | -identifiable information data? |
| | Personally Identifiable Information (PII) Data |
| | may be identified in the following list of Unique |
| | Identifiers. |
| | Have customers had their data used this way before? |
| | Is third-party data being utilized? |
| Agency & Consent | Should we make it clear to users when they are |
| | engaging with a system and not a human? If so, |
| | how will you do this? |

In the scenario that the modified data set 318 passes the determined threshold 320, the processor may conduct operations for generating machine learning models 330 based on the modified data set 318. Prior to generating or applying a results interpretation model 350 to machine learning model output, the processor may conduct operations for determining whether the machine learning model includes model behavior bias. In some examples, determining whether the machine learning model includes model behavior bias may include thresholding operations 340.

In some embodiments, the qualitative workflow may include a processing stage gate 380b. At the processing stage gate 380b, the processor may receive a qualitative data set and generate criteria data for setting up one or more model behavior threshold values 340 for model behaviour testing 342. In some embodiments, the qualitative data set may include user input associated with survey questions. For instance, survey questions may include: “What problem is the model solving?”, “Would sacrificing accuracy standards improve the fairness of the model?”, or “Are classifiers more sensitive to the optimization of a specific group?”. In some embodiments, the processor may update the model building stage 330 based on a qualitative feedback score associated with the survey questions.

In the scenario that the machine learning model output does not pass determined thresholds 340, the processor may conduct operations for model behavior testing 342. Operations associated with model behavior testing 342 include operations for generating or determining confusion matrices, precision, recall, ROC, area under the curve of the receiver operating characteristic (AU ROC), Gini index, RMSE, feature/attribute importance, or adversarial debiasing/prejudice removal. Other operations for model behaviour testing 342 may be contemplated.

Based on the model behaviour testing 342, the processor may generate a quantitative feedback score based on the determined model behavior bias for updating the machine learning models 330. In some embodiments, it may be desirable to combine quantitative feedback and qualitative feedback for updating the machine learning models 330. Accordingly, the qualitative workflow may include operations for receiving a qualitative data set and generating a qualitative feedback score for updating the machine learning models 330.

In some embodiments, the processor may receive user input associated with one or more survey questions associated with one or more of the analytical dimensions, and may transform the received user input into a qualitative data set.

In the scenario that output of the machine learning model 330 passes determined thresholds 340, the processor may conduct operations of a results interpretation model 350 to reduce output bias. Prior to providing a machine learning model output, the processor may conduct operations for determining whether the machine learning model output includes bias. In some examples, determining whether the machine learning model output includes output bias includes thresholding operations 360. Examples of thresholds include statistical thresholds associated with disparate impact removal (e.g., threshold value of 0.8 for 80% rule, for minimum ratio), ANOVA (e.g., 0.05 for p-value, assuming a 95% confidence value), equalized odds identification with a 0.8 threshold, equal opportunity identification with a 0.8 threshold, or other methods of post-processing output analysis.

In the scenario that the machine learning output does not pass determined thresholds 360, the processor may conduct output bias testing 362. Operations associated with output bias testing include equalized odds post-processing, calibrated equalized odds post-processing, reject option classification, sensitivity analysis, or layer-wise relevance propagation. Other operations for output bias testing 362 may be contemplated.

Based on the output bias testing 362, the processor may generate a quantitative feedback score based on the determined output bias for updating the results interpretation model 350.

In some embodiments, it may be desirable to combine quantitative feedback and qualitative feedback for updating the results interpretation model 350. Accordingly, the qualitative workflow may include operations for receiving a qualitative data set and generating a qualitative feedback score for updating the results interpretation model 350.

In some embodiments, the processor may receive user input associated with one or more of the analytical dimensions, and the processor may revise thresholds or scoring metrics based on the received user input. For instance, the user input may identify that a system desired disparate impact reduction threshold be 60%, rather than a default value of 80%.

In some embodiments, the qualitative workflow may include a post-processing/pre-production stage gate 380c. At the post-processing/pre-production stage gate 380c, the processor may receive a qualitative data set and generate criteria data for setting up one or more threshold values for the thresholding operations 360. The threshold operations 360 may be associated with the output bias testing 362. In some examples, the qualitative data set may include user input associated with survey questions. Example survey questions are described in the present disclosure.

Example survey questions associated with received user input for updating the results interpretation model 350 or for setting up one or more threshold values may include one or more of the following:

| | Questions/Instructions Associated with Qualitative |
|---|---|
| Dimension | Data Set Input |
| Transparency & | Will you be building in (customer-centric) model |
| Explainability | explainability into your end product? |
| | Will users understand how to interpret the outputs |
| | of your system? |
| Fairness & Bias | Would sacrificing accuracy standards improve the |
| | fairness of your model? |
| | How often should the system administrator monitor |
| | for negative impact on individuals, subgroups, or |
| | sensitive features? |
| Privacy | Do these insights create personal assumptions which |
| | could be considered a violation of privacy? |
| | Will the insights be shared outside of a Team- |
| | Member-Controlled Environment (ads, targeting)? |
| | Will you make your customer aware their data is |
| | being used in this context? (If yes, how; if no |
| | why?) |
| Agency & Consent | What type of consent would best benefit the |
| | customer for this product? |
| | Data not originating from the system is being used |
| | in this product: are you making the data source clear |
| | to the customer? |

In the scenario that the machine learning output may pass determined thresholds 360, the processor may document 390 the machine learning model 330 or criteria associated with the machine learning model 330. For example, the processor may generate documentation for managing machine learning models. In some embodiments, the processor may generate a user interface for providing classifications of the machine learning output associated with one or more of the analytical dimensions described herein. The user interface may be a text-based interface, a graphical user interface, or user interface including a combination of features for providing classifications of the machine learning output.

In some embodiments, the processor may generate documentation data sets based on user input to document characteristics (e.g., documentation) of embodiment systems described in the present disclosure. As illustrating examples, the user input may be in response to survey queries. The respective survey queries may be associated with an analytical dimension. As illustrating examples:

| | Questions/Instructions Associated with Qualitative |
|---|---|
| Dimension | Data Set Input |
| Product | What problem is your model solving for? |
| | Who is your target model consumer? |
| | Who is your target customer? |
| | Who is the product owner & final (business) |
| | decision maker for this product? |
| | Who is the developer of the model? |
| | What is the execution-frequency of the model, and |
| | how often is the model re-trained with new data? |
| Transparency & | How was the champion model selected? |
| Explainability | How was the model validated? |
| | Please explain the model. |
| Agency & Consent | How might the end-user of the model give feedback |
| | on the model's accuracy once deployed? |

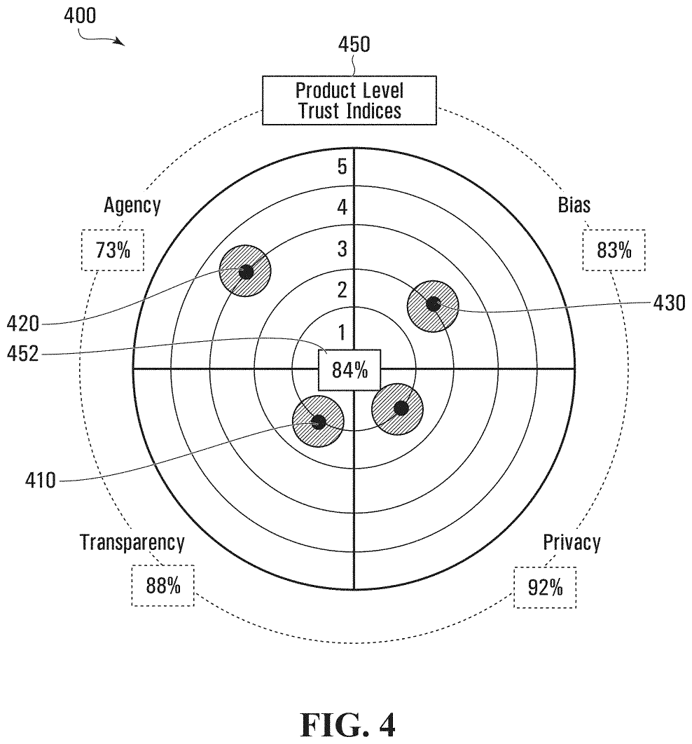

Reference is made to FIG. 4, which illustrates a graphical user interface 400 graphically illustrating classification of machine learning output, in accordance with an embodiment of the present disclosure. In some examples, the graphical user interface may be configured to identify ethical risk of the machine learning model on a spectrum spanning minimal ethical exposure to high ethical exposure. A visual interface is illustrated in FIG. 4; however, it may be appreciated that, in some other embodiments, user interfaces may be text based, or include other medium of classifying machine learning output.

The graphical user interface 400 includes gradations on a scale of 1 to 5. In the example illustrated in FIG. 4, “minimal ethical exposure” may be associated with the number “1”, “moderate ethical exposure” may be associated with the number “3”, and “high ethical exposure” may be associated with the number “5”. It may be appreciated that any other scale having any number of gradations may be implemented by distilling a combination of: qualitative data analysis and statistical analysis into a score for a model used in a particular context.

The graphical user interface 400 may be configured to include a set of quadrants. In the example illustrated in FIG. 4, each quadrant may be associated with one of the analytical dimensions described herein, such as: (i) transparency; (ii) agency & consent; (iii) bias; or (iv) privacy. Any number of analytical dimensions may be contemplated, and that the graphical user interface 400 may be configured to represent any number of analytical dimensions on a scale containing any number of gradations.

In some embodiments, the “transparency” dimension may be associated with proactive disclosure of data, methods, or controls that affect the role that machine learning output plays a user's experience of the embodiment systems described herein. In some embodiments, the “agency & consent” dimension may be associated with ability of users of the system to make choices to control their experience working within an environment of the embodiment systems described herein. In some embodiments, the “bias” dimension may be associated with the effect of (knowingly or unknowingly) making choices that privilege certain groups over others in ways that may be perceived to be unfair. In some examples, an “intentionality” dimension may be associated with a capacity to act with a clear understanding of implications of actions. In some embodiments, the “privacy” dimension may be associated with prevention of disclosure or revelation of detail about an user or user group that may be perceived as invasive or non-consensual.

In the example illustrated in FIG. 4, the processor may classify machine learning output on the basis of each of the analytical dimensions and may generate the graphical user interface to graphically illustrate a relative measure or degree of ethical exposure associated with that machine learning output. For instance, in terms of “Transparency”, the machine learning output may be classified as having “minimal ethical exposure” 410. In terms of “agency”, the machine learning output may be classified as having “moderate-to-high ethical exposure” 420. In terms of “bias”, the machine learning output may be classified as having “minimal-to-moderate ethical exposure” 430. Further, in terms of “Privacy”, the machine learning output may be classified as having “minimal ethical exposure 440”.

In some embodiments, the graphical user interface 400 may include further classifications or metrics associated with embodiment systems described in the present disclosure. For example, the graphical user interface may include product-level trust indices 450 associated with the one or more analytical dimensions. As illustrating examples, the graphical user interface 400 illustrates an 88% trust index associated with the “transparency” dimension. The graphical user interface 400 illustrates a 73% trust index associated with the agency dimension. The graphical user interface 400 illustrates a 83% trust index associated with the “bias” dimension. Further, the graphical user interface 400 illustrates a 92% trust index associated with the “privacy” dimension.

In some embodiments, the graphical user interface 400 may include an indication of an combined product-level trust index 452 based on the one or more product-level trust indices associated with the one or more analytical dimensions. In the example illustrated in FIG. 4, the combined product-level trust index 452 may be an average value of the plurality of product-level trust indices associated with the one or more analytical dimensions (e.g., mean of 88%, 73%, 83%, and 92% is 84%). Other methods for computing the combined product-level trust index 452 may be contemplated. In an example, the combined product-level trust index 452 may be a weighted combination of the plurality of product-level trust indices.

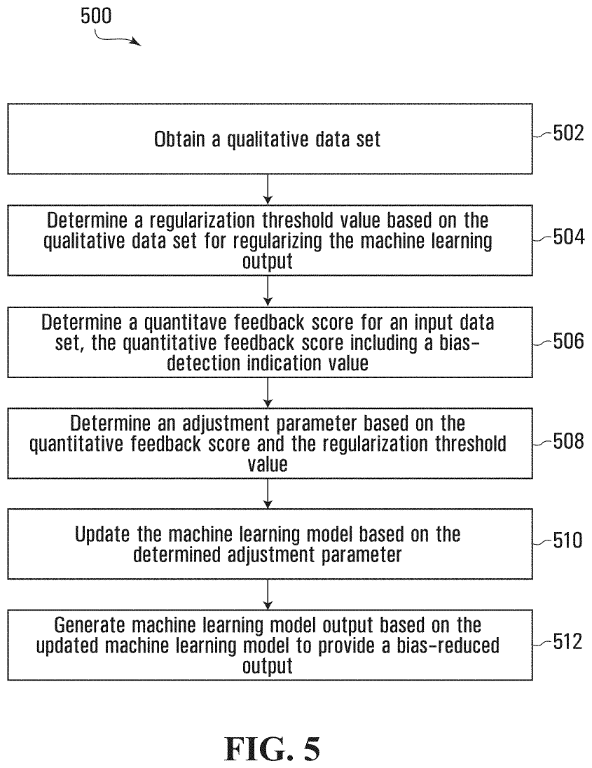

As described in the present disclosure it may be desirable to generate machine learning output based on a combination of (i) quantitative feedback and (ii) qualitative feedback to identify or reduce inherent biases of (a) machine learning models and (b) training data sets used to train the machine learning models. In some embodiments, systems and methods may be configured to combine transformed qualitative input with quantitative analysis to update machine learning models. To illustrate example methods, reference is made to FIG. 5.

FIG. 5 illustrates a flowchart of a method 500 of generating machine learning model output, in accordance with an embodiment of the present disclosure. The method 500 may be conducted by the processor 102 of the system 100 (FIG. 1). Processor readable instructions may be stored in the memory 106 and may be associated with the machine learning application 112 or other processor readable applications not illustrated in FIG. 1.

At 502, the processor may obtain a qualitative data set. The qualitative data set may be based on received user input associated with survey questions. The received user input may be qualitative, product-related data for identifying desirable analytical objectives of the system. For example, the user input may address survey queries such as: “Are customers being impacted at an individual level?”, “Does the system intend to utilize personal identifiable information (PII) data?”, “What data types (e.g., unique identifiers, PII data, sensitive attributes, etc.) shall the system focus on?”, or “How critical is learning model explainability to the use-case or to stakeholders?”.

In examples when the received user input identifies PII data of interest, the processor may extract and/or flag data entries associated with the PII data of interest for weighing or importance adjustment.

At 504, the processor may determine a regularization threshold value based on the qualitative data set for regularizing the machine learning output. For example, the regularization threshold value may be a qualitative score based on the obtained qualitative data set. For instance, the regularization threshold value may include a disparate impact ratio value, a skewness identification value, or other threshold values for identifying user desirable biases for the machine learning system. In some embodiments, the regularization threshold value may be associated with a classification of a quantitative feedback score. The classification may be binary classification, multi-class classification, based on regression, or other classification method.

At 506, the processor may determine a quantitative feedback score for an input data set. The quantitative feedback score may include a bias-detection indication value. For example, the quantitative feedback score may be a disparate impact indicator (e.g., disparity ratio). Each of one or more data entries of the input data set may be associated with a disparate impact indicator.

At 508, the processor may determine an adjustment parameter based on the quantitative feedback score and the regularization threshold value. For example, the regularization threshold value may be 0.8 and may be configured as a threshold for binary classification of the quantitative feedback score. The processor may determine an adjustment parameter (e.g., penalty parameter) associated with data features or data types.

As an illustrating example, the adjustment parameter may be determined based on the following classification of the quantitative feedback score (e.g., disparity ratio):

$${λ}_{j} = \{ \begin{matrix}1 - {DI}_{j} , {DI}_{j} < 0.8 \\ 0 , {DI}_{j} \geq 0.8\end{matrix} \} , where j represents features$$

The above adjustment parameter is based on a classification; however, other operations for determining adjustment parameters for data features may be contemplated. In some other examples, the adjustment parameter may be based on any other classification method for adjusting importance of input features independent of an output layer, such as multi-class classification or regression-based classification.

Based on the example described with reference to Table 2, Table 3 illustrates an example of how feature importance changes based on levels of disparity impacts for varying magnitudes of adjustment or penalty. Table 3 illustrates data associated with penalty=0 (e.g., regular loss function of logistic regression), λ, and 2500λ.

TABLE 3
Optimal Feature Importance

| | | | Penalized/Regularized | Penalized/Regularized |
|---|---|---|---|---|
| | | Regular Loss | Less Function for | Loss Function for |
| | | Function of Logistic | Logistic Regression | Logistic Regression |
| | Feature | Regression, | (Iteration 4, | (Iteration 10,000, |
| Features | Penalties | where ν is 0) | where ν is 1) | where ν is 2,500) |
| Dummy_1 | 1.000000 | 0.998411 | 0.987516 | 0.159676 |
| Account_Balance | 0.368229 | 0.217237 | 0.206168 | −0.109907 |
| Duration_of_Credit_month | 0.000000 | 0.019205 | 0.019136 | 0.021875 |
| Dummy_2 | 0.513514 | −0.652118 | −0.638413 | −0.091808 |
| Payment_Status_of_Previous_Credit | 0.547840 | −0.211845 | −0.208825 | −0.044630 |
| Purpose | 0.370000 | 0.020881 | 0.019779 | −0.001920 |
| Credit_Amount | 0.000000 | 0.000066 | 0.000065 | 0.000052 |
| Value_SavingsStocks | 0.263456 | −0.211700 | −0.210608 | −0.098342 |
| Length_of_current_employment | 0.223362 | −0.108584 | −0.107926 | −0.057131 |
| Instalment_per_cent | 0.000000 | 0.084225 | 0.083306 | 0.100187 |
| Sex_&_Material_Status | 0.352113 | −2.060621 | −2.012480 | −0.065753 |
| Guarantors | 0.000000 | −0.440411 | −0.438024 | −0.287490 |
| Duration_in_Current_address | 0.000000 | 0.050794 | 0.049884 | 0.010554 |
| Most_valuable_available_asset | 0.241836 | −0.024216 | −0.023694 | 0.011007 |
| Age_years | 0.000000 | −0.038087 | −0.037986 | −0.023634 |
| Concurrent_Credits | 0.000000 | −0.389983 | −0.388226 | −0.204512 |
| Type_of_apartment | 0.000000 | 0.166986 | 0.167259 | 0.122917 |
| No_of_Credits_at_this_Bank | 0.000000 | −0.105321 | −0.104912 | −0.047464 |
| Occupation | 0.000000 | −0.081870 | −0.082558 | −0.055935 |
| No_of_dependents | 0.000000 | 0.000000 | 0.000000 | 0.000000 |
| Telephone | 0.000000 | 0.000000 | 0.000000 | 0.000000 |

At 510, the processor may update the machine learning model based on the determined adjustment parameter. Referring to the example described with reference to FIG. 2, the updated machine learning model operations may be based on a penalized/regularized loss function (see e.g., regularized loss function for logistic regression in Table 2).

At 512, the processor may generate machine learning model output based on the updated machine learning model to provide a bias-reduced output. For example, the machine learning model output may include a decision or a selection to a question, such as “Should a mortgage loan with home-equity line of credit be offered to the applicant? If yes, what maximum loan limits need to be put into place?”

Systems and methods described in the present disclosure may adjust sensitive parameters while maintaining prediction accuracy based on prior determined regularization threshold values. In some examples, accuracy of logistic regression may not be affected by adjustments, while that of the regularized/penalized model may include a decreasing trend. In some examples of the present disclosure, while sensitive data feature bias may be reduced, prediction accuracy may be altered. The obtained qualitative data set may be associated with a tradeoff between data feature bias and learning model prediction accuracy.

Embodiments of the present disclosure may conduct operations to reduce bias identified in data sets, machine learning models, or machine learning model outputs based on a combination of qualitative and quantitative feedback data. In some embodiments, a quantity of bias reduction based on a combination of qualitative and quantitative feedback data may be greater than the quantity of bias reduction that may be based primarily on quantitative feedback data.

In some embodiments, the processor may generate, for display, a user interface to classify the bias-reduced output based on the at least one analytical dimension. As an illustrative example, the user interface may be the graphical user interface 400 of FIG. 4 and may classify the machine learning output for each of at least one analytical dimension. Further, the classification of the machine learning output may be on a spectrum to convey a degree of bias or ethical risk in each of the at least one analytical dimensions.

In some embodiments described in the present disclosure, a system for generating machine learning output is provided. The system may include a processor and a memory coupled to the processor. The memory may store processor-executable instructions that, when executed, configure the processor to: obtain a bias-reduced data set and generate a machine learning model based on the bias-reduced data set. The processor may determine that the machine learning model includes model behavior bias and may generate a quantitative feedback score based on the determined model behavior bias. To illustrate, the quantitative feedback score may include a disparity ratio associated with determined disparate impact. The processor may receive a qualitative data set and generate a qualitative feedback score. To illustrate, the qualitative data set may be based for example on received qualitative, product-related data collection, and the qualitative feedback score may be a regularization threshold value. Further, the processor may update the machine learning model based on a combination of the quantitative feedback score and the qualitative feedback score.

In some embodiments, obtaining the bias-reduced data set may include the processor being configured to: receiving an input data set and determining that the input data set includes data set bias. The processor may determine that the input data set includes data set bias based on one or more analytical operations that may include outlier identification, skewness or probability, distribution/mass functions, minority class detection, outlier detection, lack of attribute fairness, disparate impact remover, or re-weighting attributes. The processor may generate a quantitative data bias score based on the determined data set bias and may generate the bias-reduced data set based on a combination of the quantitative data bias score and the qualitative feedback score. To illustrate, the qualitative feedback score may be based on received user input addressing questions such as: “How neutral is the objective/goal of the model?” (Bias & Intentionality), “Based on your model classifiers, define the attribute importance” (Transparency & Explainability), etc. The processor may, subsequently, generate or refine a machine learning model based on the bias-reduced data set.

In some embodiments, the processor may determine that the machine learning model output includes output bias. In some examples, the processor may determine that the machine learning model output includes output bias based on a results interpretation model. The processor may generate a quantitative output bias score based on the determined output bias. In some examples, the quantitative output bias score may be based on one or more of equalized odds post-processing, calibrated equalized odds post-processing, reject option classification, sensitivity analysis, or layer-wise relevance propagation. The processor may update the results interpretation model to reduce any identified output bias based on a combination of the quantitative output bias score and a qualitative feedback score. In some examples, the qualitative feedback score may be based on received user input addressing questions such as: “How might the end user of the model give feedback on the model's accuracy of optimizations?” (Bias & Explainability), “Do internal users understand how to interpret the outputs of the system?” (Transparency & Explainability), etc. The processor may generate a bias-reduced decision result based on the bias-reduced data set, the updated machine learning model, and the updated results interpretation model.

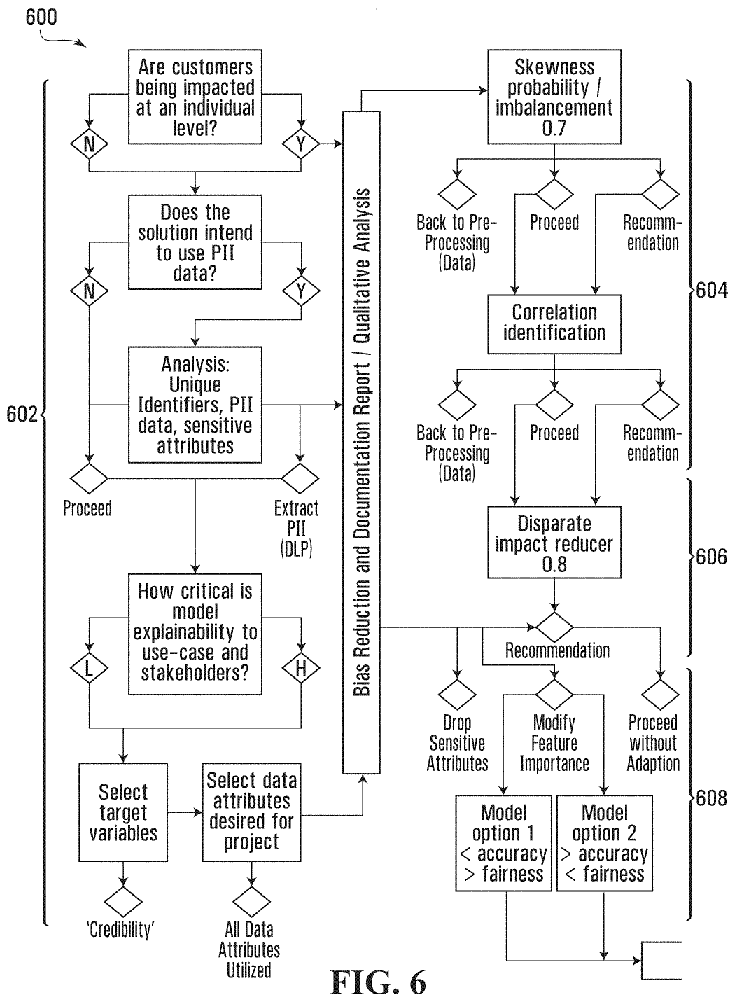

Reference is made to FIG. 6, which illustrates a flowchart of a method 600 of reducing sensitive data set feature importance based on modified weights, in accordance with an embodiment of the present disclosure. The method 600 includes operations similar to operations described with reference to FIG. 2. The method 600 may be conducted by the processor 102 of the system 100 (FIG. 1). Processor readable instructions may be stored in the memory 106 and may be associated with the machine learning application 112 or other processor readable applications not illustrated in FIG. 1.

At 602, one or more example survey questions may be provided for generating a qualitative data set. Example survey questions may include “Are customers being impacted at an individual level?” or “Does the solution intend to use PII data?”.

In scenarios where the processor receives user input indicating “no” to the above described survey questions, the processor may proceed to receiving further user input of survey questions.

In scenarios where the processor receives user input indicating “yes” to the above described survey questions, the processor may conduct operations associated with reducing importance of sensitive data set features, in accordance with embodiments of the present disclosure. For example, the processor may extract PII data types and conduct operations of data bias reduction.

In some examples, one or more survey questions may include “How critical is model explainability to use-case and stakeholders?”. Based on the received user input indicating importance (to a user) of model explainability, the processor may conduct operations for selecting subsets of target features of an input data set for machine learning modelling. For instance, in some embodiments, the processor may identify a subset of target features of the input data set that are predefined for predicting creditability of an entity (e.g., creditability of an entity for a mortgage loan).

In some examples, the received user input may include indications of target features of the input data set that the user may require to configure the machine learning model system. In some embodiments, operations for bias reduction and documentation reporting or for qualitative analysis may correspond to example operations described with reference to FIG. 2 at 212 and 214.

In some embodiments, the processor may determine regularization threshold values based on user input associated with the survey questions. For example, regularization threshold values may include thresholds for identifying skewness, correlation, disparate impact, or other example analytical measures. As will be described below, the regularization threshold values may include a disparate impact ratio threshold value, skewness threshold value, or other threshold values for identifying adjustment parameters for updating machine learning models.

At 604, the processor may conduct operations for determining a quantitative feedback measure for an input data set. To illustrate, the input data set may be the modified German Credit data set described in the present disclosure, or any other data set that a machine learning system may receive as input. In some embodiments, quantitative feedback measures may include disparity impact ratios, statistical parity, predictive parity, or skewness measures.

In some embodiments, the processor may determine a quantitative feedback measure and, subsequently, (i) conduct operations to further pre-process the input data set, (ii) proceed with further operations to determine quantitative feedback measures, or (iii) provide recommendations to further operations for determining quantitative feedback measures (e.g., at 604).

At 606, the processor may determine one or more adjustment parameters based on the quantitative feedback measures and regularization threshold values. For instance, the processor may determine a penalty parameter (e.g., λⱼ in an example with reference to FIG. 2) based on identified disparate impact and a binary classification threshold value (e.g., 0.8, corresponding to a disparate impact “80% rule”). At 606, the processor may update a machine learning model based on the one or more adjustment parameters. In the scenario that the processor identifies disparate impact associated with a data entry greater than the binary classification threshold value, the processor may update the machine learning model with a loss function based on the one or more adjustment parameters.

In some embodiments, the processor, at 608, may evaluate two or more methods of updating the machine learning model and identify the machine learning model update method based on prior received qualitative data sets (e.g., user input). In some embodiments, the processor may discard sensitive data features, may modify data feature weightings, or may discard any modelling changes to the machine learning model.

In some scenarios, machine learning model updates may include tradeoffs between bias/fairness and prediction accuracy. In some scenarios, a reduction in bias/fairness (e.g., indicated in a qualitative data set) in exchange for reduced model prediction accuracy may be based on identified undesirable behavior (e.g., where identified behavior may be identified in user input associated with a received qualitative data set). For instance, the identified behavior may be ethical bias, or other machine learning model intentions.

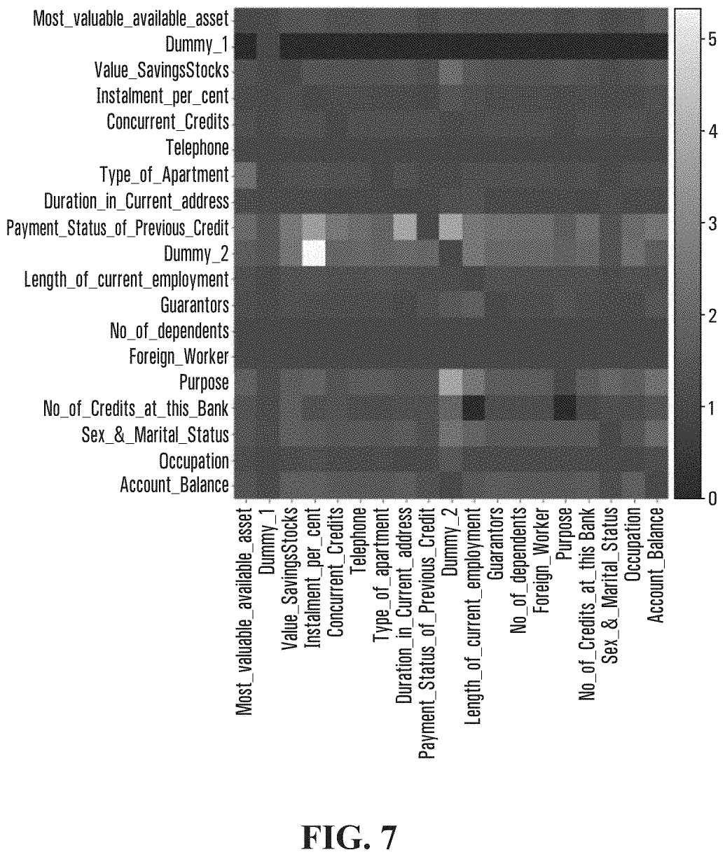

Reference is made to FIG. 7, which illustrates a sample bias mitigation report 700, in accordance with an embodiment of the present disclosure. The sample bias mitigation report 700 may be a graphical representation of correlations or multi-collinearity among features of a data set. In the illustration of FIG. 7, the graphical representation may be based on a modified German Credit data set described in the present disclosure.

As a non-limiting illustration, predictive parity may be expressed as positive values. For a pair of features with a parity ratio of 1, the features may satisfy predictive parity. For a pair of features with a parity ratio of greater than 1, the features may not satisfy predictive parity. In some embodiments, the sample bias mitigation report 700 may be a heat map. For example, lighter shaded/colored regions of the heat map may identify pairs of features that fail to satisfy predictive parity.

In some embodiments, the processor may generate embodiments of the bias mitigation report 700 at operations associated with reference numeral 214 of FIG. 2.

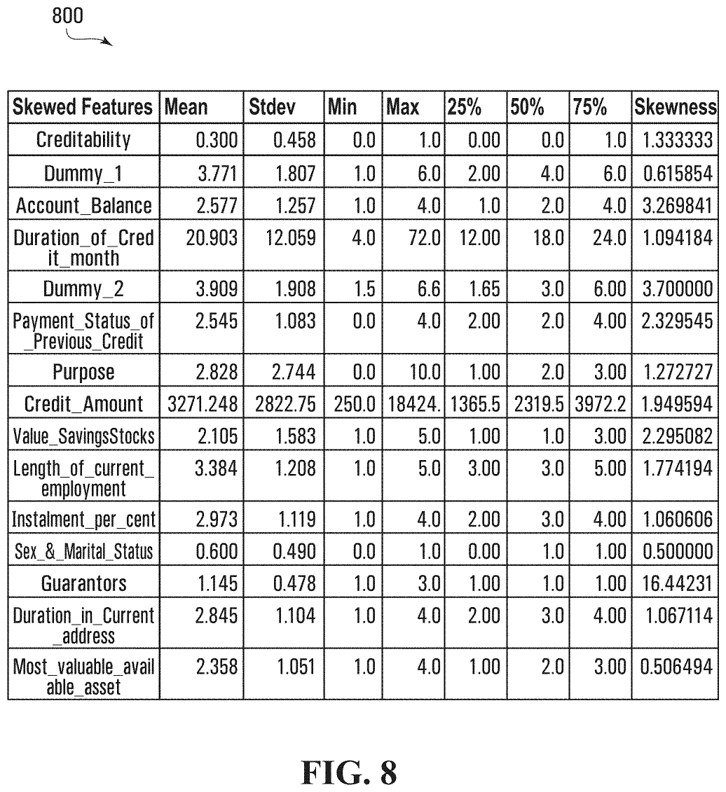

Reference is made to FIG. 8, which illustrates a sample of a component of a bias mitigation report 800, in accordance with another embodiment of the present disclosure. The sample portion of the bias mitigation report 800 may be in tabular form, and may summarize skewness analysis of one or more data attributes. In some embodiments, the processor may generate embodiments of the bias mitigation report 800 at operations associated with reference numeral 214 of FIG. 2.

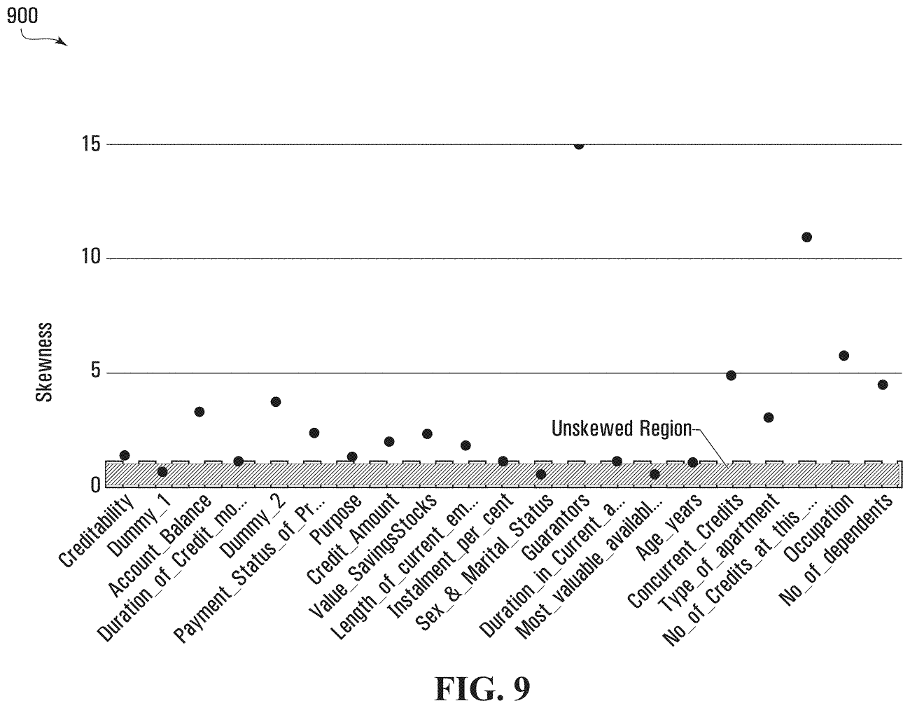

Reference is made to FIG. 9, which illustrates a sample of a component of a bias mitigation report 900, in accordance with another embodiment of the present disclosure. The sample portion of the bias mitigation report 900 may be in graphical form, and may graphically illustrate skewness analysis associated with the respective data attributes. The graphical interface may include graphical indicators highlighting particular data attributes that may be associated with an unskewed region. In some embodiments, the processor may generate embodiments of the bias mitigation report 900 at operations associated with reference numeral 214 of FIG. 2.

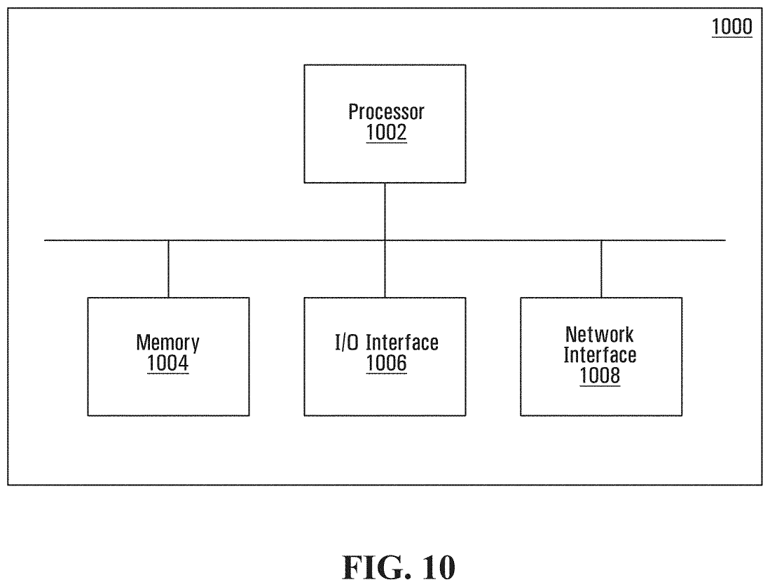

Reference is made to FIG. 10, which illustrates a block diagram of a computing device 1000, in accordance with an embodiment of the present disclosure. As an example, the system 100 or the client device 110 of FIG. 1 may be implemented using the example computing device 1000 of FIG. 10.

The computing device 1000 includes at least one processor 1002, memory 1004, at least one I/O interface 1006, and at least one network communication interface 1008.

The processor 1002 may be a microprocessor or microcontroller, a digital signal processing (DSP) processor, an integrated circuit, a field programmable gate array (FPGA), a reconfigurable processor, a programmable read-only memory (PROM), or combinations thereof.

The memory 1004 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

The I/O interface 1006 may enable the computing device 1000 to interconnect with one or more input devices, such as a keyboard, mouse, camera, touch screen and a microphone, or with one or more output devices such as a display screen and a speaker.

The networking interface 1008 may be configured to receive and transmit data sets representative of the machine learning models, for example, to a target data storage or data structures. The target data storage or data structure may, in some embodiments, reside on a computing device or system such as a mobile device.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

What is claimed is:

1. A system for generating machine learning model output, the system comprising:
a communication device;
a processor coupled to the communication device; and
a memory coupled to the processor and storing processor-executable instructions that, when executed, configure the processor to:
obtain a bias-reduced data set;
generate a machine learning model based on the bias-reduced data set;
determine that the machine learning model includes model behaviour bias;
generate a quantitative feedback score based on the determined model behaviour bias;
receive a qualitative data set and generate a qualitative feedback score based on the qualitative data set; and
update the machine learning model based on a combination of the quantitative feedback score and the qualitative feedback score.

2. The system of claim 1, wherein the qualitative data set is associated with user input received by the system, and wherein the qualitative feedback score is associated with a regularization threshold value, and wherein the quantitative feedback score is based on disparate impact,
and wherein updating the machine learning model includes:
determining an adjustment parameter based on the quantitative feedback score and the qualitative feedback score; and
determining a loss function for a regression model based on the adjustment parameter.

3. The system of claim 1, wherein the qualitative feedback score is associated with at least one analytical dimension, and wherein the processor-executable instructions, when executed, configure the processor to:
generate the machine learning model output based on the bias-reduced data set and the updated machine learning model to provide a bias-reduced output; and
generating, for display, a user interface to classify the bias-reduced output based on the at least one analytical dimension.

4. The system of claim 3, wherein the at least one analytical dimension includes at least one of transparency & explainability, bias & intentionality, privacy, or agency & consent.

5. The system of claim 1, wherein determining that the machine learning model includes model behaviour bias is based on at least one bias-detecting threshold.

6. The system of claim 1, wherein the quantitative feedback score is based on at least one of root mean square error identification, area under the curve of the receiver operating characteristic (AUROC) identification, confusion matrices, or shapley additive explanations (SHAP).

7. The system of claim 1, wherein obtaining the bias-reduced data set comprises:
receiving an input data set;
determining that the input data set includes data set bias;
generating a quantitative data bias score based on the determined data set bias; and
generating the bias-reduced data set based on a combination of the quantitative data bias score and the qualitative feedback score.

8. The system of claim 6, wherein the quantitative data bias score is based on at least one of outlier identification, probability mass or distribution function, skew distribution or outlier data identification, predictive parity identification, minority class identification, disparate impact, or analysis of variance (ANOVA).

9. The system of claim 1, wherein the memory includes processor-executable instructions that, when executed, configure the processor to:
determine that the machine learning model output includes output bias;
generate a quantitative output bias score based on the determined output bias;
update a results interpretation model to reduce the output bias based on a combination of the quantitative output bias score and the qualitative feedback score; and
generate a bias-reduced decision result based on the bias-reduced data set, the updated machine learning model, and the updated results interpretation model,
and wherein generating the user interface includes classifying the bias-reduced decision result based on the at least one analytical dimension.

10. The system of claim 9, wherein updating the results interpretation model is based on at least one of sensitivity analysis, reject option classification, or equalized odds identification.

11. A method for generating machine learning model output comprising:
obtaining a bias-reduced data set;
generating a machine learning model based on the bias-reduced data set;
determining that the machine learning model includes model behaviour bias;
generating a quantitative feedback score based on the determined model behaviour bias;
receiving a qualitative data set and generate a qualitative feedback score based on the qualitative data set; and
updating the machine learning model based on a combination of the quantitative feedback score and the qualitative feedback score.

12. A system for generating machine learning model output from an input data set, the system comprising:
a processor;
a memory coupled to the processor and storing processor-executable instructions that, when executed, configure the processor to:
obtain a qualitative data set;
determine a regularization threshold value based on the qualitative data set for regularizing the machine learning output;
determine a quantitative feedback score for the input data set, wherein the quantitative feedback score includes a bias-detection indication value;
determine an adjustment parameter based on the quantitative feedback score and the regularization threshold value; and
update the machine learning model based on the determined adjustment parameter.

13. The system of claim 12, wherein the quantitative feedback score includes a disparate impact ratio associated with the input data set, and wherein the regularization threshold value is associated with a binary classification of the quantitative feedback score.

14. The system of claim 12, wherein the qualitative data set is associated with an analytical dimension including at least one of transparency & explainability, bias & intentionality, privacy, or agency & consent.

15. The system of claim 12, wherein the processor-executable instructions, when executed, configure the processor to:
generate machine learning output based on the updated machine learning model and the input data set; and
generate, for display, a user interface to classify the machine learning output based on at least one analytical dimension, wherein the at least one analytical dimension includes at least one of transparency & explainability, bias & intentionality, privacy, or agency & consent.

16. The system of claim 12, wherein determining the quantitative feedback score is based on at least one of root mean square error identification, area under the curve of the receiver operating characteristic (AUROC) identification, confusion matrices, or shapley additive explanations (SHAP).

17. The system of claim 12, wherein the quantitative feedback score being a bias-detection indication value is based on at least one of disparate impact, predictive parity identification, minority class identification, outlier identification, probability mass or distribution function, skew distribution or outlier data identification, or analysis of variance (ANOVA).

18. The system of claim 12, wherein updating the machine learning model includes determining a loss function for a regression model based on the adjustment parameter for reducing feature importance for a data type associated with the quantitative feedback score beyond the regularization threshold value.

19. The system of claim 18, wherein the regression model is a logistic model having a logistic regression function including:
$${h}_{θ} ( z ) = \frac{1}{1 + {e}^{- {θ}^{{T}_{z}}}} .$$

20. The system of claim 19, wherein the loss function includes:
$${J}_{λ} = \frac{- 1}{m} [ {\sum }_{i = 1}^{m} {y}_{i} log ( {h}_{θ} ( {x}_{i} ) ) + ( 1 - {y}_{i} ) log ( 1 - {h}_{θ} ( {x}_{i} ) ) ] + \frac{y}{2 m} {\sum }_{j = 1}^{n} {λ}_{j}^{*} {θ}_{j}^{2}$$
wherein λⱼ* is the adjustment parameter, (x, y) are data points, m is the number of data points, n is the number of features, θ is the feature importance that is optimized using loss function, and v is a constant.

21. A method for generating machine learning model output from an input data set comprising:
obtaining a qualitative data set;
determining a regularization threshold value based on the qualitative data set for regularizing the machine learning output;
determining a quantitative feedback score for the input data set, wherein the quantitative feedback score includes a bias-detection indication value;
determining an adjustment parameter based on the quantitative feedback score and the regularization threshold value; and
updating the machine learning model based on the determined adjustment parameter.
